(19) United States
(12) Patent Application Publication
(10) Pub. No.: US 2012/0295176 A1
(43) Pub. Date: Nov. 22, 2012

(54) FUEL CELL

(75) Inventors: Narutoshi SUGITA, Utsunomiya-shi (JP); Tetsuya NAKAMURA, Utsunomiya-shi (JP); Daisuke OKONOGI, Utsunomiya-shi (JP); Keisuke ANDO, Saitama-shi (JP); Yoshiro ICHIKAWA, Tochigi-ken (JP); Kentaro ISHIDA, Utsunomiya-shi (JP)

(73) Assignee: HONDA MOTOR CO., LTD., TOKYO (JP)

(21) Appl. No.: 13/472,637

(22) Filed: May 16, 2012

(30) Foreign Application Priority Data
May 20, 2011 (JP) 2011-113319

(51) Int. Cl. H01M 8/24; H01M 8/00; H01M 8/04

(52) U.S. Cl. 429/434; 429/535

(57) ABSTRACT

A cell unit of a fuel cell includes a first membrane electrode assembly, a first metal separator, a second membrane electrode assembly, and a second metal separator. Resin frame members are provided at outer ends the first and second membrane electrode assemblies. A dual seal provided on the resin frame member includes an outer seal member and an inner seal member. A front end of the outer seal member contacts the resin frame member, and a front end of the inner seal member contacts the outer end of the first metal separator. The outer seal member and the outer seal member have the same height.

### CROSS-REFERENCE TO RELATED APPLICATION

This application is based upon and claims the benefit of priority from Japanese Patent Application No. 2011-113319 filed on May 20, 2011, of which the contents are incorporated herein by reference.

### BACKGROUND OF THE INVENTION

1. Field of the Invention

The present invention relates to a fuel cell including cell units each formed by stacking an electrolyte electrode assembly and a metal separator. The electrolyte electrode assembly includes a pair of electrodes and an electrolyte interposed between the electrodes. A coolant flow field for allowing a coolant to flow along a separator surface is formed between the adjacent cell units.

2. Description of the Related Art

For example, a solid polymer electrolyte fuel cell employs a membrane electrode assembly (electrolyte electrode assembly) (MEA) which includes an anode, a cathode, and a solid polymer electrolyte membrane interposed between the anode and the cathode. The solid polymer electrolyte membrane is a polymer ion exchange membrane. Each of the anode and the cathode includes an electrode catalyst layer and a porous carbon layer. The membrane electrode assembly and separators (bipolar plates) sandwiching the membrane electrode assembly make up a unit cell. In use, generally, a predetermined number of unit cells are stacked together to form a fuel cell stack mounted in a vehicle.

In general, mostly, the fuel cell of this type adopts so called internal manifold structure where a fuel gas supply passage and a fuel gas discharge passage as passages of a fuel gas, an oxygen-containing gas supply passage and an oxygen-containing gas discharge passage as passages of an oxygen-containing gas, and a coolant supply passage and a coolant discharge passage as passages of a coolant extend through the cell units in the stacking direction.

Therefore, in the separators, a plurality of fluid passages, i.e., the fuel gas supply passage, the fuel gas discharge passage, the oxygen-containing gas supply passage, the oxygen-containing gas discharge passage, the coolant supply passage, and the coolant discharge passage are provided. Thus, the area of the separators is considerably large. In particular, in the case where metal separators are adopted as the separators, the amount of expensive material such as stainless steel used for the separators is increased, and the unit cost of the part becomes high.

In this regard, in a fuel cell formed by stacking a membrane electrode assembly (electrolyte electrode assembly) and a metal separator, it is suggested to adopt structure where a resin frame (resin frame member) is provided at the outer end of the electrolyte electrode assembly, fluid passages extend through the frame, and the metal separator is positioned inside the fluid passages.

In the fuel cell of this type, special seal structure is required for sandwiching the metal separator between a pair of the frames. For example, in a fuel cell disclosed in Japanese Laid-Open Patent Publication No. 2005-276820, though the above structure of the membrane electrode assembly with the frame is not adopted, dual seal structure is adopted.

In the fuel cell, as shown in FIG. 27, a solid electrolyte membrane 2 protrudes outwardly from a membrane electrode assembly 1, and the solid electrolyte membrane 2 is sandwiched between a first separator 3 and a second separator 4. The first separator 3 has a dual seal 5 including an inner seal 5a which contacts a solid electrolyte membrane 2, and an outer seal 5b which contacts a flat seal member 6 provided on the second separator 4.

### SUMMARY OF THE INVENTION

However, in the dual seal 5, the height of the inner seal 5a is different from the height of the outer seal 5b. The inner seal 5a and the outer seal 5b have different seal lip shapes. Therefore, two types of seal designs are required for the inner seal 5a and the outer seal 5b uneconomically.

The present invention has been made to solve the problem of this type, and an object of the present invention is to provide a fuel cell having simple and economical dual seal structure which makes it possible to reduce the production cost effectively.

The present invention relates to a fuel cell formed by stacking electrolyte electrode assemblies and metal separators in a stacking direction. The electrolyte electrode assemblies each include a pair of electrodes, and an electrolyte interposed between the electrodes.

A resin frame member is provided integrally with each outer end of the electrolyte electrode assemblies of the fuel cell. A plurality of fluid passages extend through the resin frame members in the stacking direction for allowing fluids of a fuel gas, an oxygen-containing gas, and a coolant to flow through the fluid passages. Each of the metal separators is interposed between a pair of resin frame members, inwardly of the fluid passages inside outer ends of the resin frame members.

A dual seal including an inner seal member and an outer seal member having the same height is provided on one of the pair of resin frame members. A front end of the inner seal member contacts one of the metal separators, and a front end of the outer seal member contacts the other of the pair of resin frame members.

In the present invention, the outer seal member and the inner seal member have the same height. Thus, the inner seal member and the outer seal member can have the same seal lip shape. Therefore, the outer seal member and the inner seal member can be produced with the same design, i.e., one type of seal design. As a result, the dual seal can be produced simply and economically, and the production cost of the entire fuel cell can be reduced effectively.

The above and other objects, features and advantages of the present invention will become more apparent from the following description when taken in conjunction with the accompanying drawings in which preferred embodiments of the present invention are shown by way of illustrative example.

### BRIEF DESCRIPTION OF THE DRAWINGS

FIG. 1 is an exploded perspective view showing a fuel cell according to a first embodiment of the present invention;

FIG. 2 is a cross sectional view showing the fuel cell, taken along a line II-II in FIG. 1;

FIG. 3 is a view showing a cathode surface of a first membrane electrode assembly of the fuel cell;

FIG. 4 is a view showing an anode surface of the first membrane electrode assembly;

FIG. 5 is a view showing a cathode surface of a second membrane electrode assembly of the fuel cell;

FIG. 6 is a view showing an anode surface of the second membrane electrode assembly;

FIG. 7 is a view showing a cathode surface of a first metal separator of the fuel cell;

FIG. 8 is a view showing an anode surface of the first metal separator;

FIG. 9 is a view showing a cathode surface of a second metal separator of the fuel cell;

FIG. 10 is a view showing an anode surface of the second metal separator;

FIG. 11 is a cross sectional view showing the fuel cell, taken along a line XI-XI in FIG. 1;

FIG. 12 is a cross sectional view showing the fuel cell, taken along a line XII-XII in FIG. 1;

FIG. 13 is a cross sectional view showing the fuel cell, taken along a line XIII-XIII in FIG. 1;

FIG. 14 is a cross sectional view showing the fuel cell, taken along a line XIV-XIV in FIG. 1;

FIG. 15 is an exploded perspective view showing a fuel cell according to a second embodiment of the present invention;

FIG. 16 is a cross sectional view showing the fuel cell, taken along a line XVI-XVI-in FIG. 15;

FIG. 17 is a view showing a cathode surface of the first membrane electrode assembly of the fuel cell;

FIG. 18 is a view showing an anode surface of the first membrane electrode assembly;

FIG. 19 is a view showing a cathode surface of a second membrane electrode assembly of the fuel cell;

FIG. 20 is a view showing an anode surface of the second membrane electrode assembly;

FIG. 21 is a view showing a cathode surface of a first metal separator of the fuel cell;

FIG. 22 is a view showing a cathode surface of a second metal separator of the fuel cell;

FIG. 23 is a view showing an anode surface of the second metal separator;

FIG. 24 is a cross sectional view showing the fuel cell, taken along a line XXIV-XXIV in FIG. 15;

FIG. 25 is a cross sectional view showing the fuel cell, taken along a line XXV-XXV in FIG. 15;

FIG. 26 is a cross sectional view showing the fuel cell, taken along a line XXVI-XXVI in FIG. 15; and

FIG. 27 is a cross sectional view showing an anode separator of a fuel cell disclosed in Japanese Laid-Open Patent Publication No. 2005-276820.

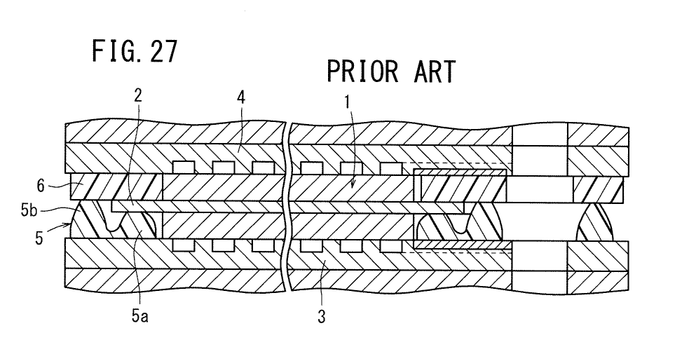

### DESCRIPTION OF THE PREFERRED EMBODIMENTS

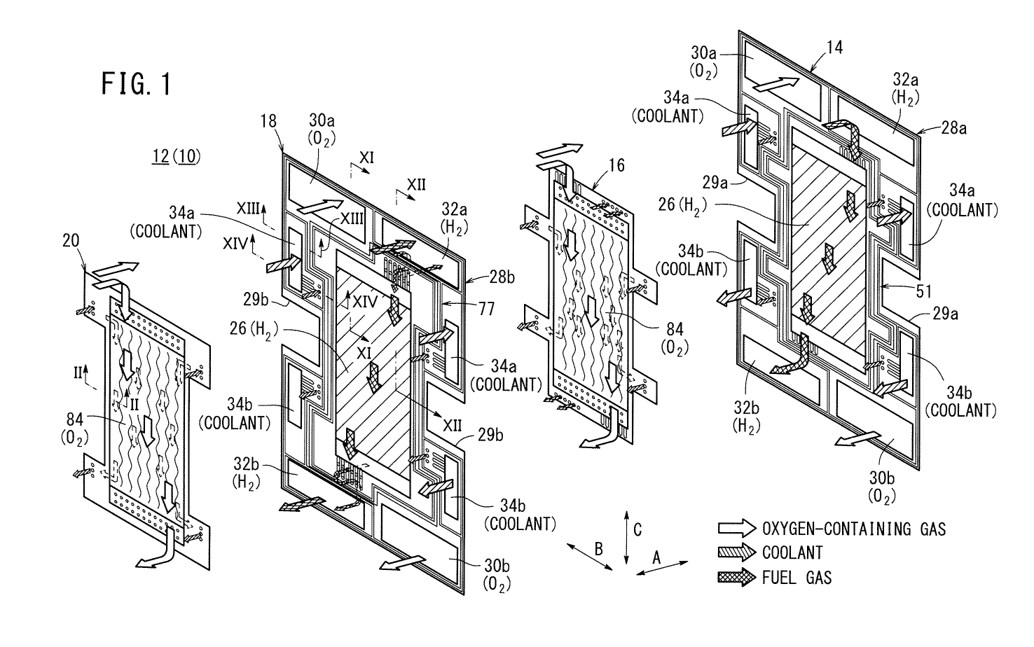

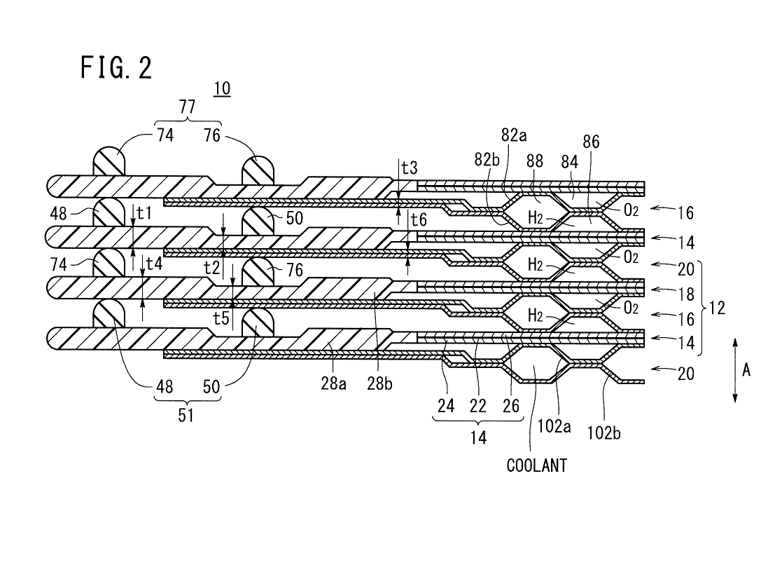

As shown in FIGS. 1 and 2, a fuel cell 10 according to a first embodiment of the present invention is formed by stacking a plurality of cell units 12 in a horizontal direction indicated by an arrow A.

The cell unit 12 includes a first membrane electrode assembly (electrolyte electrode assembly) (MEA) 14, a first metal separator 16, a second membrane electrode assembly (electrolyte electrode assembly) (MEA) 18, and a second metal separator 20. By stacking the cell units 12, the first membrane electrode assembly 14 is sandwiched between the second and first metal separators 20, 16, and the second membrane electrode assembly 18 is sandwiched between the first and second metal separators 16, 20.

Each of the first membrane electrode assembly 14 and the second membrane electrode assembly 18 includes a cathode 24, an anode 26, and a solid polymer electrolyte membrane (electrolyte) 22 interposed between the cathode 24 and the anode 26 (see FIG. 2). The solid polymer electrolyte membrane 22 is formed by impregnating a thin membrane of perfluorosulfonic acid with water, for example.

In the solid polymer electrolyte membrane 22, the surface area of the cathode 24 and the surface area of the anode 26 are the same. It should be noted that the outer circumferential portion of the solid polymer electrolyte membrane 22 may protrude beyond the cathode 24 and the anode 26. The surface area of the cathode 24 may be different from the surface area of the anode 26.

In the first membrane electrode assembly 14, a resin frame member 28a made of insulating polymer material is formed integrally with the outer circumferential edges of the solid polymer electrolyte membrane 22, the cathode 24 and the anode 26, e.g., by injection molding. Likewise, in the second membrane electrode assembly 18, a resin frame member 28b made of polymer material is formed integrally with the outer circumferential edges of the solid polymer electrolyte membrane 22, the cathode 24 and the anode 26, e.g., by injection molding. For example, engineering plastics and super engineering plastics as well as commodity plastics may be adopted as the polymer material.

As shown in FIG. 1, each of the resin frame members 28a, 28b has a substantially rectangular shape elongated in a direction indicated by an arrow C. A pair of recesses 29a, 29b are formed centrally in each of the resin frame members 28a, 28b by cutting the central portion of each long side inwardly.

Each of the cathode 24 and the anode 26 has a gas diffusion layer (not shown) such as a carbon paper, and an electrode catalyst layer (not shown) of platinum alloy supported on porous carbon particles. The carbon particles are deposited uniformly on the surface of the gas diffusion layer.

As shown in FIG. 1, at one end (upper end) of the resin frame members 28a, 28b in a vertical direction indicated by an arrow C, an oxygen-containing gas supply passage 30a for supplying an oxygen-containing gas (reactant gas) and a fuel gas supply passage 32a for supplying a fuel gas (reactant gas) such as a hydrogen-containing gas are arranged in a horizontal direction in a direction indicated by an arrow B.

At the other end (lower end) of the resin frame members 28a, 28b in the vertical direction indicated by the arrow C, a fuel gas discharge passage 32b for discharging the fuel gas and an oxygen-containing gas discharge passage 30b for discharging the oxygen-containing gas are arranged in the direction indicated by the arrow B.

At upper positions at both ends of the resin frame members 28a, 28b in the direction indicated by the arrow B, a pair of coolant supply passages 34a for supplying a coolant are provided, and at lower positions at both ends of the resin frame members 28a, 28b in the direction indicated by the arrow B, a pair of coolant discharge passages 34b for discharging the coolant are provided. The coolant supply passages 34a and the coolant discharge passages 34b extend through the resin frame members 28a, 28b in the direction indicated by the arrow A.

The coolant supply passages 34a are positioned adjacent to the oxygen-containing gas supply passage 30a and the fuel gas supply passage 32a, separately on the sides (other pair of sides) at both ends in the direction indicated by the arrow B. The coolant discharge passages 34b are positioned adjacent to the oxygen-containing gas discharge passage 30b and the fuel gas discharge passage 32b, separately on the sides at both ends in the direction indicated by the arrow B. The coolant supply passages 34a and the coolant discharge passages 34b may be provided upside down. That is, the coolant supply passages 34a may be positioned adjacent to the oxygen-containing gas discharge passage 30b and the fuel gas discharge passage 32b.

In the first and second membrane electrode assemblies 14, 18, on one pair of opposite sides, i.e., on both of upper and lower short sides, the oxygen-containing gas supply passage 30a and the fuel gas supply passage 32a, and the oxygen-containing gas discharge passage 30b and the fuel gas discharge passage 32b are provided, and on the other pair of opposite sides, i.e., on both of left and right long sides, the pair of coolant supply passages 34a and the pair of coolant discharge passages 34b are provided.

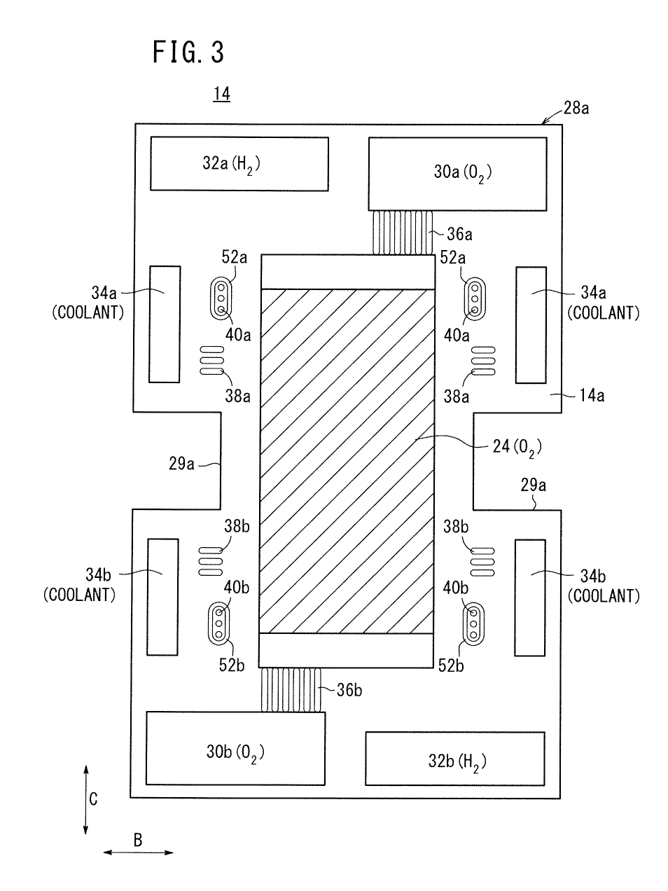

As shown in FIG. 3, the resin frame member 28a has a plurality of inlet grooves 36a at upper positions of the cathode surface (the surface where the cathode 24 is provided) 14a of the first membrane electrode assembly 14 and adjacent to the lower side of the oxygen-containing gas supply passage 30a. Further, the resin frame member 28a has a plurality of inlet grooves 38a at upper positions at both ends of the cathode surface 14a in the width direction indicated by the arrow B and adjacent to the lower side of the coolant supply passages 34a. A plurality of inlet holes 40a extend through the resin frame member 28a at positions adjacent to the upper side of the coolant supply passages 34a.

The resin frame member 28a has a plurality of outlet grooves 36b at lower positions of the cathode surface 14a of the first membrane electrode assembly 14 and adjacent to the upper side of the oxygen-containing gas discharge passage 30b. Further, the resin frame member 28a has a plurality of outlet grooves 38b at lower positions at both ends of the cathode surface 14a in the width direction and adjacent to the upper side of the coolant discharge passages 34b. A plurality of outlet holes 40b extend through the resin frame member 28a at positions adjacent to the lower side of the coolant discharge passages 34b.

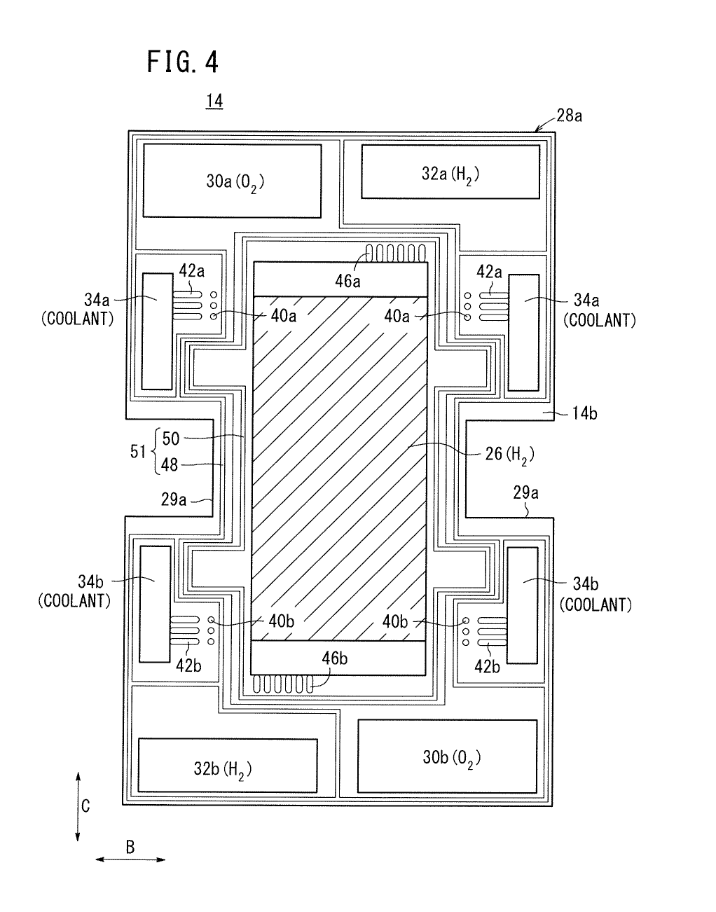

As shown in FIG. 4, the resin frame member 28a has a plurality of inlet grooves 42a at upper positions on both ends of the anode surface (the surface where the anode 26 is provided) 14b of the first membrane electrode assembly 14 in the width direction and adjacent to the upper side of the coolant supply passages 34a. The resin frame member 28a has a plurality of outlet grooves 42b at lower positions on both ends of the anode surface 14b in the width direction and adjacent to lower portions of the coolant discharge passages 34b.

The resin frame member 28a has a plurality of inlet grooves 46a below the fuel gas supply passage 32a, and a plurality of outlet grooves 46b above the fuel gas discharge passage 32b.

An outer seal member (outer seal line) 48 and an inner seal member (inner seal line) 50 are provided integrally with the anode surface 14b of the resin frame member 28a to form a dual seal 51. Alternatively, the outer seal member 48 and the inner seal member 50 may be formed separately from the resin frame member 28a, and provided on the anode surface 14b of the resin frame member 28a to form the dual seal 51. Each of the outer seal member 48 and the inner seal member 50 is made of seal material, cushion material or packing material such as an EPDM rubber (ethylene propylene diene monomer), an NBR (nitrile butadiene rubber), a fluoro rubber, a silicone rubber, a fluorosilicone rubber, a butyl rubber, a natural rubber, a styrene rubber, a chloroprene rubber, or an acrylic rubber. Seal members as described later have the same structure as those of the outer seal member 48 and the inner seal member 50, and description thereof will be omitted.

The outer seal member 48 is provided along the outer circumferential end of the resin frame member 28a and around all of the fluid passages, i.e., the oxygen-containing gas supply passage 30a, the coolant supply passages 34a, the fuel gas supply passage 32a, the oxygen-containing gas discharge passage 30b, the coolant discharge passages 34b and the fuel gas discharge passage 32b and around the reaction surface (power generation surface). The outer seal member 48 surrounds respectively the coolant supply passages 34a, the fuel gas supply passage 32a, the coolant discharge passages 34b and the fuel gas discharge passage 32b. The outer seal member 48 surrounds the inlet grooves 42a, the inlet holes 40a and the coolant supply passages 34a together, and surrounds the outlet grooves 42b, the outlet holes 40b and the coolant discharge passages 34b together. The inner seal member 50 is positioned inside the outer seal member 48, and surrounds the anode 26, the inlet grooves 46a and the outlet grooves 46b together. The inner seal member 50 is provided along a profile line corresponding to the outer shape of the first metal separator 16, and contacts the entire outer circumferential surface of the first metal separator 16 (within the separator surface) (see FIG. 2). The outer seal member 48 is provided around the outer end of the first metal separator 16 (outside the separator surface), and the front end of the outer seal member 48 contacts the resin frame member 28b. All of the fluid passages are hermetically surrounded by the outer seal member 48 and the inner seal member 50.

As shown in FIG. 2, in the resin frame member 28a (one of the resin frame members), the thickness t1 of a portion where the outer seal member 48 is provided is larger than the thickness t2 of a portion where the inner seal member 50 is provided (t1>t2). The difference between the thickness t1 and the thickness t2 is equal to the thickness t3 of the first metal separator 16 (t1−t2=t3).

The resin frame member 28b (the other of the resin frame members) has a flat surface from a portion which contacts the outer seal member 48 to a portion facing the inner seal member 50. The outer seal member 48 and the inner seal member 50 have the same height, and the same seal lip shape.

As shown in FIG. 3, on the cathode surface 14a of the resin frame member 28a, a ring-shaped inlet seal member 52a surrounding the inlet holes 40a and a ring-shaped outlet seal member 52b surrounding the outlet holes 40b are provided.

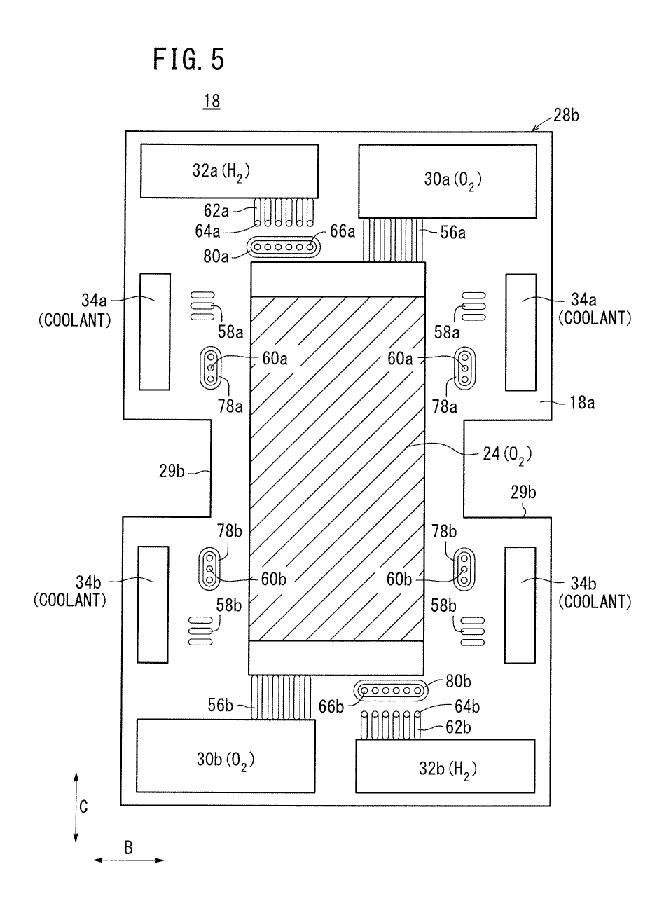

As shown in FIG. 5, the resin frame member 28b has a plurality of inlet grooves 56a at upper positions of the cathode surface (the surface where the cathode 24 is provided) 18a of the second membrane electrode assembly 18 and adjacent to the lower side of the oxygen-containing gas supply passage 30a.

The resin frame member 28b has a plurality of inlet grooves 58a at upper positions on both ends of the cathode surface 18a in the width direction and adjacent to the upper side of the coolant supply passages 34a. A plurality of inlet holes 60a are formed adjacent to the lower side of the coolant supply passages 34a. The inlet holes 60a of the second membrane electrode assembly 18 are offset from the inlet holes 40a of the first membrane electrode assembly 14 such that the inlet holes 60a and the inlet holes 40a are not overlapped with each other in the stacking direction.

The resin frame member 28b has a plurality of inlet grooves 62a at upper positions of the cathode surface 18a and adjacent to the lower side of the fuel gas supply passage 32a. A plurality of inlet holes 64a extend through the resin frame member 28b at the lower ends of the inlet grooves 62a. A plurality of inlet holes 66a extend through the resin frame member 28b below the inlet holes 64a and at positions spaced at predetermined distances from the inlet holes 64a.

The resin frame member 28b has a plurality of outlet grooves 58b at lower positions on both ends of the cathode surface 18a in the width direction and adjacent to the lower side of the coolant discharge passages 34b. A plurality of outlet holes 60b are formed adjacent to the upper side of the coolant discharge passages 34b. The outlet holes 60b of the second membrane electrode assembly 18 are offset from the outlet holes 40b of the first membrane electrode assembly 14 such that the outlet holes 60b and the outlet holes 40b are not overlapped with each other in the stacking direction.

The resin frame member 28b has a plurality of outlet grooves 62b at lower positions of the cathode surface 18a and adjacent to the upper side of the fuel gas discharge passage 32b. A plurality of outlet holes 64b extend through the resin frame member 28b at the upper ends of the outlet grooves 62b. A plurality of outlet holes 66b extend through the resin frame member 28b above the outlet holes 64b and at positions spaced at predetermined distances from the outlet holes 64b.

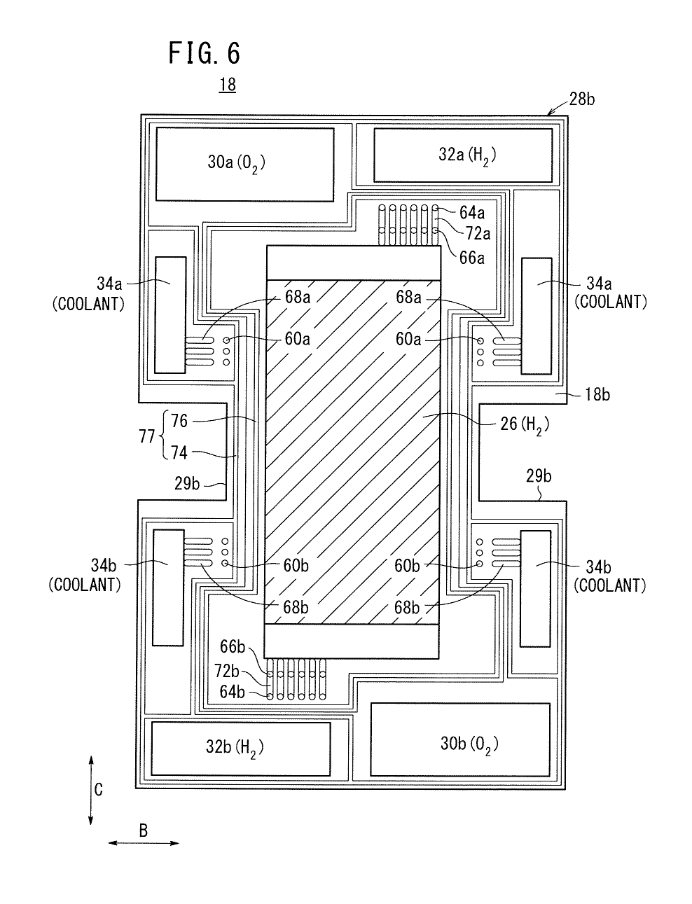

As shown in FIG. 6, the resin frame member 28b has a plurality of inlet grooves 68a at upper positions on both sides of the anode surface (the surface where the anode 26 is provided) 18b of the second membrane electrode assembly 18 in the width direction and adjacent to the lower side of the coolant supply passages 34a. The resin frame member 28b has a plurality of inlet grooves 72a below the fuel gas supply passage 32a. The inlet grooves 72a connect the inlet holes 64a, 66a with each other.

The resin frame member 28b has a plurality of outlet grooves 68b at lower positions on both ends of the anode surface 18b in the width direction and adjacent to the upper side of the coolant discharge passages 34b. The resin frame member 28b has a plurality of outlet grooves 72b above the fuel gas discharge passage 32b. The outlet grooves 72b connect the outlet holes 64b, 66b with each other.

An outer seal member (outer seal line) 74 and an inner seal member (inner seal line) 76 are provided integrally with the anode surface 18b of the resin frame member 28b to form a dual seal 77. Alternatively, the outer seal member 74 and the inner seal member 76 may be formed separately from the resin frame member 28b, and provided on the anode surface 18b of the resin frame member 28b to form the dual seal 77. The outer seal member 74 is provided along the outer circumferential end of the resin frame member 28b and around all of the fluid passages, i.e., the oxygen-containing gas supply passage 30a, the coolant supply passages 34a, the fuel gas supply passage 32a, the oxygen-containing gas discharge passage 30b, the coolant discharge passages 34b and the fuel gas discharge passage 32b.

The outer seal member 74 surrounds the coolant supply passages 34a, the fuel gas supply passage 32a, the coolant discharge passages 34b and the fuel gas discharge passage 32b. The outer seal member 74 surrounds the inlet grooves 68a, the inlet holes 60a and the coolant supply passages 34a together, and surrounds the outlet grooves 68b, the outlet holes 60b and the coolant discharge passages 34b together.

The inner seal member 76 is positioned inside the outer seal member 74, and surrounds the anode 26, the inlet holes 64a, 66a, the inlet grooves 72a, the outlet holes 64b, 66b and the outlet grooves 72b together. The inner seal member 76 is provided along a profile line corresponding to the outer shape of the second metal separator 20, and contacts the entire outer circumferential surface of the second metal separator 20. The outer seal member 74 is provided outwardly of the outer circumferential end of the second metal separator 20 such that a front end of the outer seal member 74 contacts the resin frame member 28a. All of the fluid passages are hermetically surrounded by the outer seal member 74 and the inner seal member 76.

As shown in FIG. 2, in the resin frame member 28b (one of the resin frame members), the thickness t4 of a portion where the outer seal member 74 is provided is larger than the thickness t5 of a portion where the inner seal member 76 is provided (t4>t5). The difference between the thickness t4 and the thickness t5 is equal to the thickness t6 of the second metal separator 20 (t4−t5=t6).

The resin frame member 28a (the other of the resin frame members) has a flat surface from a portion which contacts the outer seal member 74 to a portion facing the inner seal member 76. The outer seal member 74 and the inner seal member 76 have the same height, and the same seal lip shape.

As shown in FIG. 5, on the cathode surface 18a of the resin frame member 28b, ring-shaped inlet seal members 78a, 80a surrounding the inlet holes 60a, 66a and ring-shaped outlet seal members 78b, 80b surrounding the outlet holes 60b, 66b are provided.

The first and second metal separators 16, 20 are dimensioned to have profiles that the first and second metal separators 16, 20 are provided inwardly of the outer circumferential ends of the resin frame members 28a, 28b and inside the oxygen-containing gas supply passage 30a, the coolant supply passages 34a, the fuel gas supply passage 32a, the oxygen-containing gas discharge passage 30b, the coolant discharge passages 34b and the fuel gas discharge passage 32b (all of the fluid passages).

As shown in FIG. 2, the first metal separator 16 includes two metal plates (e.g., stainless plates) 82a, 82b having the same outer shape. The metal plates 82a, 82b are stacked together. The outer circumferential edges of the metal plates 82a, 82b are welded or bonded together, and the internal space between the metal plates 82a, 82b is closed hermetically. An oxygen-containing gas flow field 84 facing the cathode 24 is formed on the metal plate 82a, and a fuel gas flow field 86 facing the anode 26 is formed on the metal plate 82b. A coolant flow field 88 is formed between the metal plates 82a, 82b.

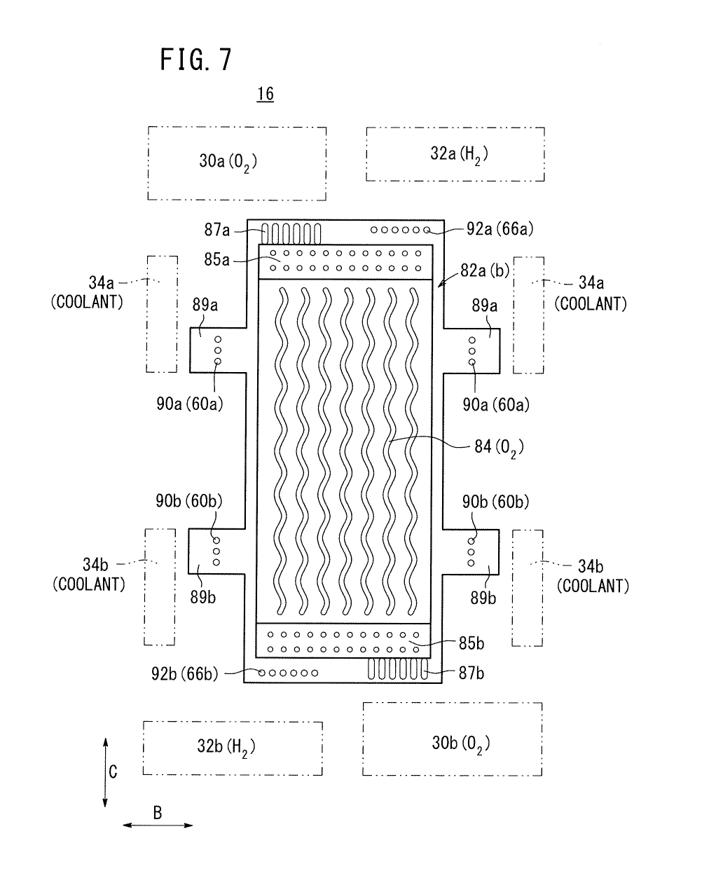

As shown in FIG. 7, the first metal separator 16 has the oxygen-containing gas flow field 84 in a surface of the metal plate 82a, and which includes a plurality of wavy flow grooves extending in the vertical direction indicated by the arrow C. An inlet buffer 85a is provided on the upstream side of the oxygen-containing gas flow field 84, and an outlet buffer 85b is provided on the downstream side of the oxygen-containing gas flow field 84. A plurality of inlet grooves 87a are formed above the inlet buffer 85a and below the oxygen-containing gas supply passage 30a, and a plurality of outlet grooves 87b are formed below the outlet buffer 85b and above the oxygen-containing gas discharge passage 30b.

The first metal separator 16 has a rectangular shape elongated in a direction indicated by an arrow C. At both ends in a lateral direction indicated by an arrow B, a pair of projections 89a protruding toward lower portions of the coolant supply passages 34a, and a pair of projections 89b protruding toward upper portions of the coolant discharge passages 34b are provided. In the metal plate 82a, a plurality of holes 90a are formed in the projections 89a, and the holes 90a are connected to the inlet holes 60a of the second membrane electrode assembly 18. Further, in the metal plate 82a, a plurality of holes 90b are formed in the projections 89b, and the holes 90b are connected to the outlet holes 60b of the second membrane electrode assembly 18.

A plurality of holes 92a are formed at upper positions of the metal plate 82a, and the holes 92a are connected to the inlet holes 66a of the second membrane electrode assembly 18. A plurality of holes 92b are formed at lower positions of the metal plate 82a, and the holes 92b are connected to the outlet holes 66b of the second membrane electrode assembly 18. The holes 92a, 92b are also formed in the metal plate 82b, and extend through the first metal separator 16.

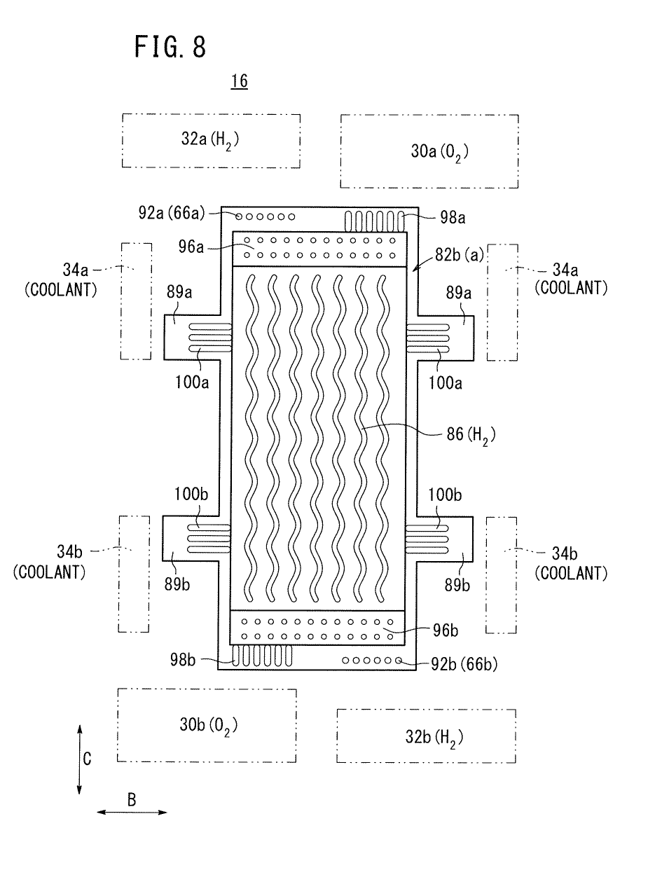

As shown in FIG. 8, the first metal separator 16 has the fuel gas flow field 86 in a surface of the metal plate 82b and which includes a plurality of wavy flow grooves extending in a vertical direction indicated by the arrow C. An inlet buffer 96a is provided on the upstream side of the fuel gas flow field 86, and an outlet buffer 96b is provided on the downstream side of the fuel gas flow field 86. A plurality of inlet grooves 98a are formed above the inlet buffer 96a and below the oxygen-containing gas supply passage 30a, and a plurality of outlet grooves 98b are formed below the outlet buffer 96b and above the oxygen-containing gas discharge passage 30b.

A plurality of inlet grooves 100a are formed in the projections 89a and adjacent to the lower portions of the coolant supply passages 34a. A plurality of outlet grooves 100b are formed in the projections 89b and adjacent to the upper portions of the coolant discharge passages 34b.

As shown in FIG. 2, the second metal separator 20 includes two metal plates (e.g., stainless plates) 102a, 102b having the same outer shape. The metal plates 102a, 102b are stacked together. The outer circumferential edges of the metal plates 102a, 102b are welded or bonded together, and the internal space between the metal plates 102a, 102b is closed hermetically. An oxygen-containing gas flow field 84 facing the cathode 24 is formed on the metal plate 102a, and a fuel gas flow field 86 facing the anode 26 is formed on the metal plate 102b. A coolant flow field 88 is formed between the metal plates 102a, 102b.

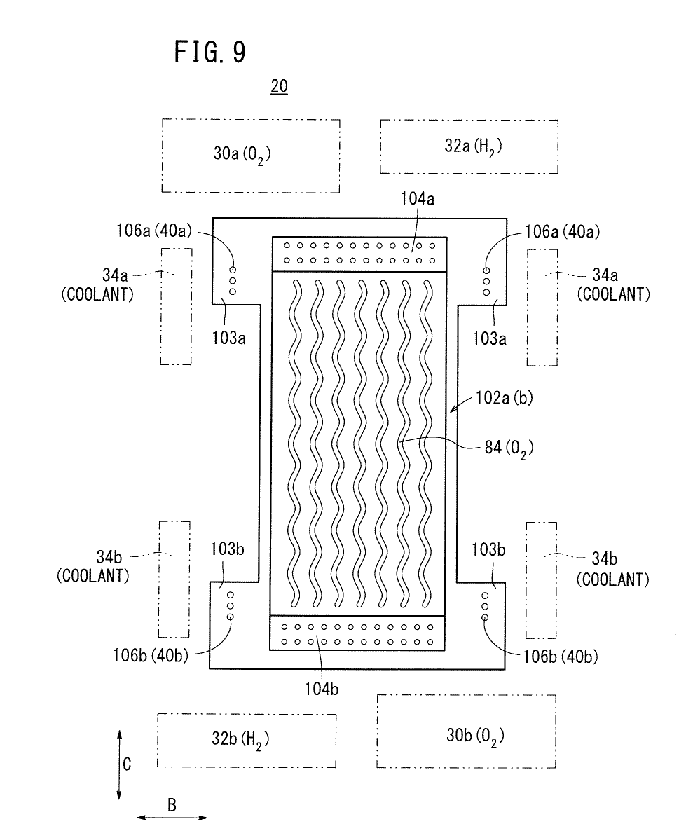

As shown in FIG. 9, the second metal separator 20 has pairs of projections 103a, 103b at both ends in the direction indicated by the arrow C. The projections 103a, 103b protrude outwardly in the direction indicated by the arrow B. The oxygen-containing gas flow field 84 is provided in the surface of the metal plate 102a. The oxygen-containing gas flow field 84 includes a plurality of flow grooves extending in the vertical direction indicated by the arrow C. An inlet buffer 104a is provided on the upstream side of the oxygen-containing gas flow field 84, and an outlet buffer 104b is provided on the downstream side of the oxygen-containing gas flow field 84.

In the metal plate 102a, a plurality of holes 106a are formed in the projections 103b and adjacent to upper portions of the coolant supply passages 34a. The holes 106a are connected to the inlet holes 40a of the first membrane electrode assembly 14. Further, in the metal plate 102a, a plurality of holes 106b are formed in the projections 103b and adjacent to lower portions of the coolant discharge passages 34b. The holes 106b are connected to the outlet holes 40b of the first membrane electrode assembly 14.

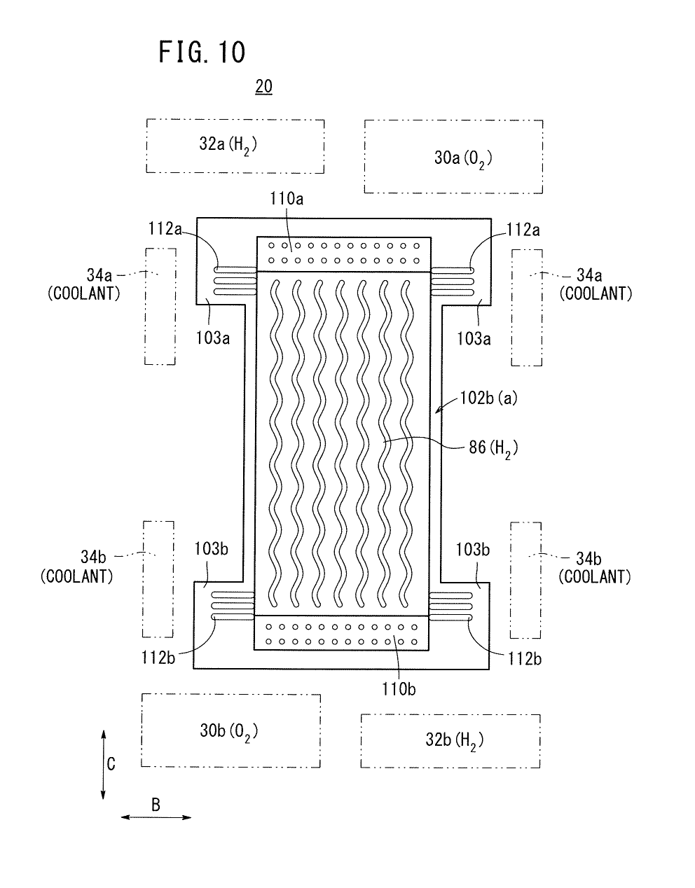

As shown in FIG. 10, the second metal separator 20 has the fuel gas flow field 86 in a surface of the metal plate 102b. The fuel gas flow field 86 includes a plurality of flow grooves extending in the vertical direction indicated by the arrow C. An inlet buffer 110a is provided on the upstream side of the fuel gas flow field 86, and an outlet buffer 110b is provided on the downstream side of the fuel gas flow field 86.

A plurality of inlet grooves 112a are formed in the projections 103a of the metal plate 102b and adjacent to the upper side of the coolant supply passages 34a, and a plurality of outlet grooves 112b are formed in the projections 103b of the metal plate 102b and adjacent to the lower side of the coolant discharge passages 34b. Both of the inlet grooves 112a and the outlet grooves 112b have corrugated structure to form coolant channels in the second metal separator 20.

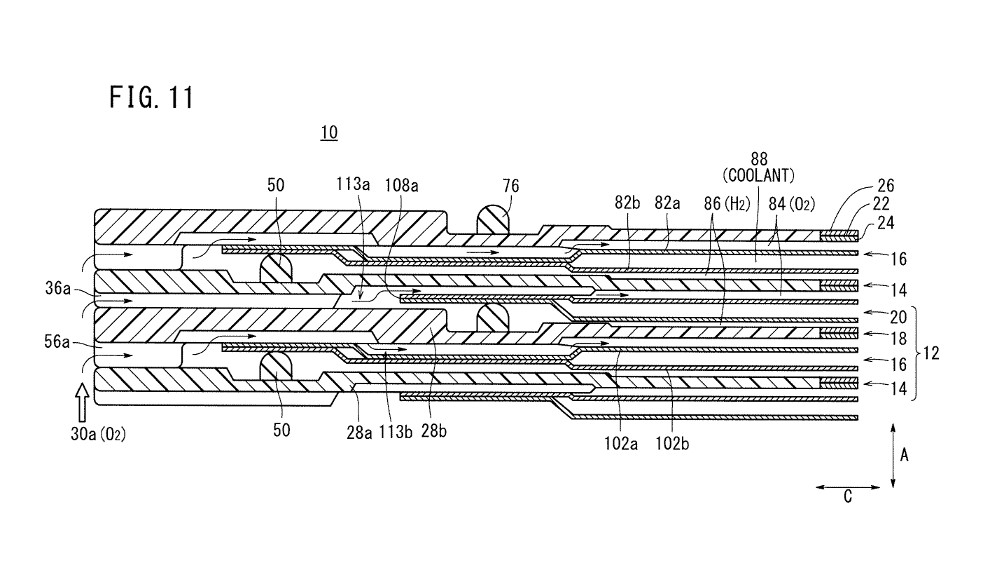

As shown in FIG. 11, an oxygen-containing gas connection channel 113a and an oxygen-containing gas connection channel 113b are formed between the resin frame members 28a, 28b that are adjacent to each other in the stacking direction. The oxygen-containing gas connection channel 113a connects the oxygen-containing gas supply passage 30a with the oxygen-containing gas flow field 84 of the second membrane electrode assembly 18, and the oxygen-containing gas connection channel 113b connects the oxygen-containing gas supply passage 30a with the oxygen-containing gas flow field 84 of the first membrane electrode assembly 14. Though not shown, an oxygen-containing gas connection channel connecting the oxygen-containing gas discharge passage 30b with the oxygen-containing gas flow field 84 is formed between the resin frame members 28a, 28b.

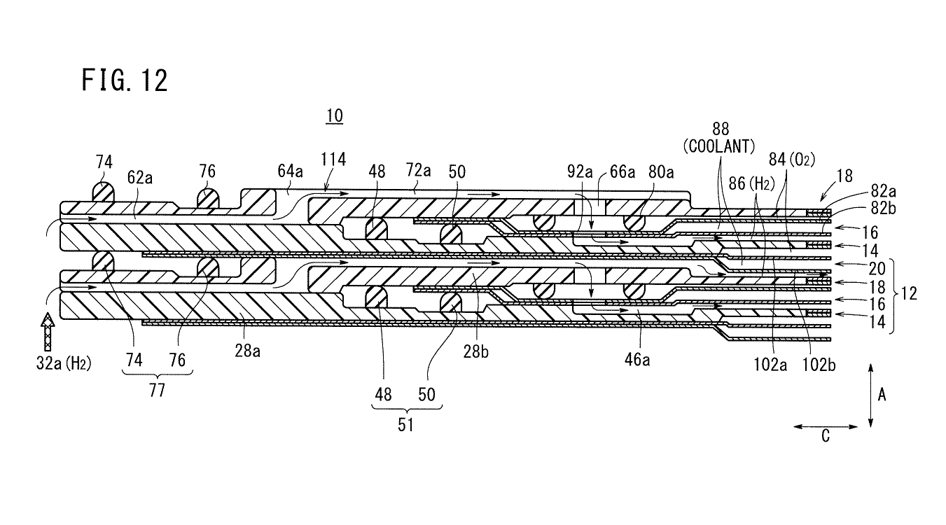

As shown in FIG. 12, a fuel gas connection channel 114 is formed between the resin frame members 28a, 28b that are adjacent to each other in the stacking direction. The fuel gas connection channel 114 connects the fuel gas supply passage 32a with the fuel gas flow field 86. Though not shown, a fuel gas connection channel connecting the fuel gas discharge passage 32b with the fuel gas flow field 86 is formed between the resin frame members 28a, 28b.

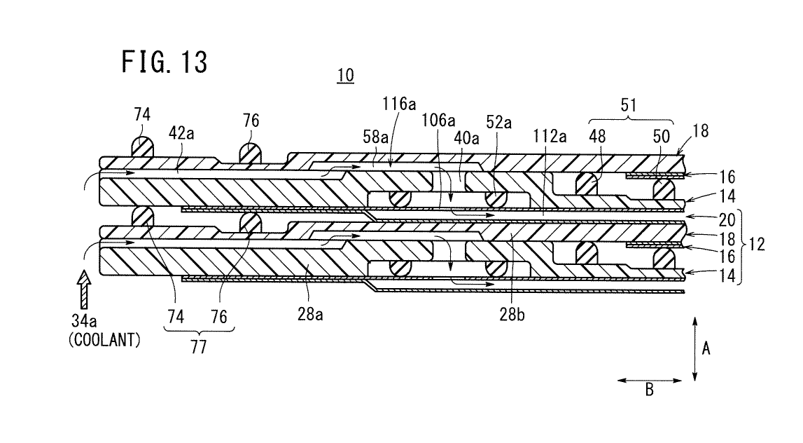

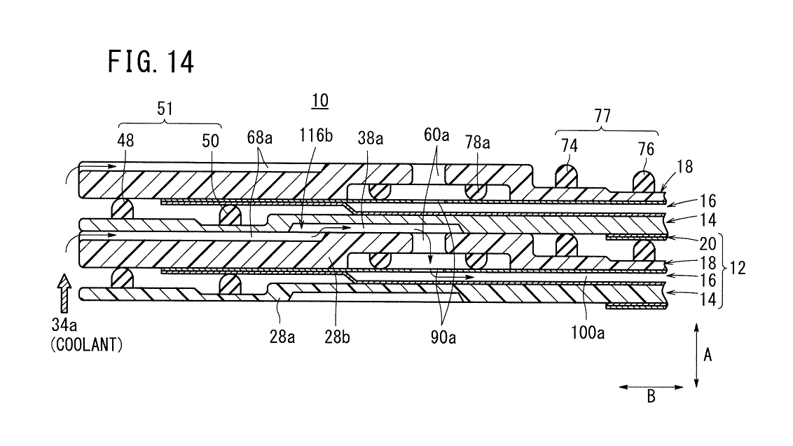

As shown in FIGS. 13 and 14, a coolant connection channel 116a and a coolant connection channel 116b are formed between the resin frame members 28a, 28b that are adjacent to each other in the stacking direction. The coolant connection channel 116a connects the coolant supply passage 34a with the coolant flow field 88 of the second metal separator 20. The coolant connection channel 116b connects the coolant supply passage 34a with the coolant flow field 88 of the first metal separator 16. Though not shown, a coolant connection channel connecting the coolant discharge passage 34b with the coolant flow field 88 is formed between the resin frame members 28a, 28b.

The coolant connection channels 116a, 116b are formed by placing the outer seal member 48 and the inner seal member 50 of the resin frame member 28a, and the outer seal member 74 and the inner seal member 76 of the resin frame member 28b at different positions in the stacking direction.

As shown in FIG. 13, the coolant connection channel 116a includes the inlet grooves 42a, 58a provided along the separator surface, the inlet holes (first holes) 40a formed in the resin frame member 28a in the stacking direction, and the holes (second holes) 106a formed in the metal plate 102a of the second metal separator 20 in the stacking direction. Ends of the inlet grooves 42a and ends of the inlet grooves 58a are connected together.

As shown in FIG. 14, the coolant connection channel 116b includes the inlet grooves 68a, 38a provided along the separator surface, the inlet holes (first holes) 60a formed in the resin frame member 28b in the stacking direction, and the holes (second holes) 90a formed in the metal plate 82a of the first metal separator 16 in the stacking direction. Ends of the inlet grooves 68a and ends of the inlet grooves 38a are connected together.

The inlet holes 40a and the holes 106a of the resin frame member 28a and the inlet holes 60 and the holes 90a of the resin frame member 28b are not overlapped with each other in the stacking direction.

Operation of this fuel cell 10 will be described below.

As shown in FIG. 1, an oxygen-containing gas is supplied to the oxygen-containing gas supply passage 30a, and a fuel gas such as a hydrogen-containing gas is supplied to the fuel gas supply passage 32a. Further, a coolant such as pure water, ethylene glycol or the like is supplied to the pair of coolant supply passages 34a.

In each of the cell units 12, as shown in FIGS. 1 and 11, the oxygen-containing gas supplied to the oxygen-containing gas supply passage 30a flows into the inlet grooves 36a of the first membrane electrode assembly 14 and into the inlet grooves 56a of the second membrane electrode assembly 18.

The oxygen-containing gas from the inlet grooves 36a is supplied to the oxygen-containing gas flow field 84 of the second metal separator 20. Then, the oxygen-containing gas is supplied from the oxygen-containing gas flow field 84 to the cathode 24 of the first membrane electrode assembly 14. After the oxygen-containing gas is consumed in the power generation reaction, the remaining oxygen-containing gas is discharged through the outlet grooves 36b into the oxygen-containing gas discharge passage 30b.

In the meanwhile, the oxygen-containing gas from the inlet grooves 56a flows through the inlet grooves 87a between the second membrane electrode assembly 18 and the first metal separator 16, and then, the oxygen-containing gas is supplied to the oxygen-containing gas flow field 84 of the first metal separator 16. The oxygen-containing gas from the oxygen-containing gas flow field 84 is supplied to the cathode 24 of the second membrane electrode assembly 18. After the oxygen-containing gas is consumed in the power generation reaction, the remaining oxygen-containing gas is discharged through the outlet grooves 87b, 56b into the oxygen-containing gas discharge passage 30b.

Further, as shown in FIGS. 1 and 12, the fuel gas supplied to the fuel gas supply passage 32a flows into the inlet grooves 62a at the cathode 24 of the second membrane electrode assembly 18. The fuel gas from the inlet grooves 62a moves toward the anode 26 through the inlet holes 64a, and then, the fuel gas is partially supplied from the inlet grooves 72a to the fuel gas flow field 86 of the second metal separator 20.

The remaining fuel gas flows through the inlet holes 66a and the holes 92a of the first metal separator 16, and then, flows into between the first metal separator 16 and the first membrane electrode assembly 14. Thereafter, the fuel gas is supplied to the fuel gas flow field 86 of the first metal separator 16.

After the fuel gas is consumed in the power generation reaction in the fuel gas flow field 86 of the second metal separator 20, the fuel gas is discharged into the outlet grooves 72b. Then, the fuel gas is discharged from the outlet holes 64b through the outlet grooves 62b into the fuel gas discharge passage 32b. In the meanwhile, after the fuel gas is consumed in the power generation reaction in the fuel gas flow field 86 of the first metal separator 16, the fuel gas is discharged from the holes 92b through the outlet holes 66b into the outlet grooves 72b. Then, likewise, the fuel gas is discharged into the fuel gas discharge passage 32b.

Thus, in each of the first membrane electrode assembly 14 and the second membrane electrode assembly 18, the oxygen-containing gas supplied to the cathode 24 and the fuel gas supplied to the anode 26 are consumed in electrochemical reactions at catalyst layers of the cathode 24 and the anode 26 for generating electricity.

Further, as shown in FIGS. 1 and 13, the coolant supplied to the pair of the coolant supply passages 34a partially flows into the inlet grooves 42a of the first membrane electrode assembly 14, and then, the coolant is supplied from the inlet grooves 58a to the inlet holes 40a. The coolant from the inlet holes 40a flows through the holes 106a of the second metal separator 20 into the second metal separator 20.

The coolant flows inside the second metal separator 20 along the inlet grooves 112a from both sides inwardly toward each other in the direction indicated by the arrow B, and the coolant is supplied to the coolant flow field 88. The coolant flowing from both sides toward each other inwardly collides at the center of the coolant flow field 88 in the direction indicated by the arrow B, and moves downwardly, in the direction of gravity indicated by the arrow C. Then, the coolant is distributed toward both sides in the direction indicated by the arrow B at a lower portion of the coolant flow field 88. The coolant flows from the outlet grooves 112b through the holes 106b, and the coolant is discharged from the second metal separator 20. Further, the coolant flows from the outlet holes 40b to the outlet grooves 58b, 42b, and the coolant is discharged into the coolant discharge passages 34b.

In the meanwhile, as shown in FIGS. 1 and 14, the remaining coolant supplied to the coolant supply passages 34a partially flows into the inlet grooves 68a of the second membrane electrode assembly 18, and then, the coolant flows through the inlet grooves 38a to the inlet holes 60a. The coolant from the inlet holes 60a flows though the holes 90a of the first metal separator 16, and then, the coolant flows into the first metal separator 16.

The coolant flows along the inlet grooves 100a inside the first metal separator 16 in the direction indicated by the arrow B, and flows inwardly from both sides in the direction indicated by the arrow B. Then, the coolant is supplied to the coolant flow field 88. After the coolant moves along the coolant flow field 88 in the direction of gravity indicated by the arrow C, the coolant is distributed toward both sides in the direction indicated by the arrow B. The coolant flows from the outlet grooves 100b to the holes 90b, and then, the coolant is discharged from the first metal separator 16. Further, the coolant from the outlet holes 60b flows through the outlet grooves 38b, 68b and then, the coolant is discharged into the coolant discharge passages 34b.

Thus, the first membrane electrode assembly 14 and the second membrane electrode assembly 18 are cooled by the coolant flowing through the coolant flow field 88 in the first metal separator 16 and the coolant flow field 88 in the second metal separator 20.

In the first embodiment, as shown in FIGS. 2 and 12 to 14, the dual seal 51 provided on the resin frame member 28a includes the outer seal member 48 and the inner seal member 50. A front end of the outer seal member 48 contacts the resin frame member 28b, and a front end of the inner seal member 50 contacts the outer end of the first metal separator 16. The outer seal member 48 and the inner seal member 50 have the same height, and the same seal lip shape.

Therefore, the outer seal member 48 and the inner seal member 50 can be produced with the same design, i.e., one type of seal design. As a result, the dual seal 51 can be produced simply and economically, and the production cost can be reduced effectively.

Further, as shown in FIGS. 2 and 12 to 14, the dual seal 77 provided on the resin frame member 28b includes the outer seal member 74 and the inner seal member 76. A front end of the outer seal member 74 contacts the resin frame member 28a, and the front end of the inner seal member 76 contacts an outer end of the second metal separator 20. The outer seal member 74 and the inner seal member 76 have the same height, and the same seal lip shape.

Therefore, the outer seal member 74 and the inner seal member 76 can be produced with the same design, i.e., one type of seal design. Thus, the dual seal 77 can be produced simply and economically, and the production cost can be reduced effectively.

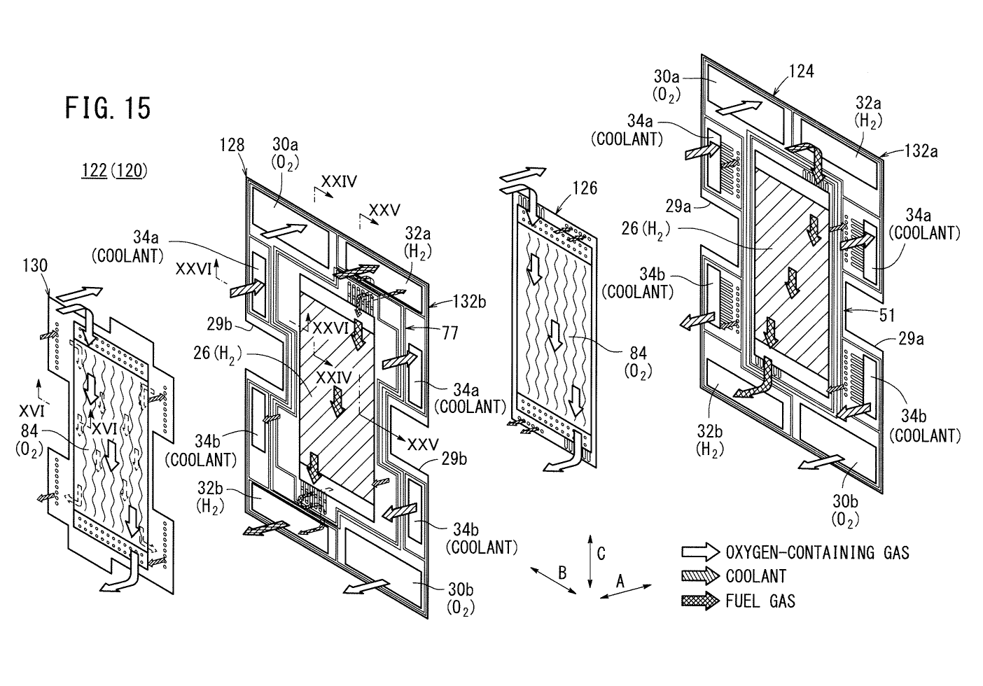

FIG. 15 is an exploded perspective view showing a fuel cell 120 according to a second embodiment of the present invention. The constituent elements of the fuel cell 120 that are identical to those of the fuel cell 10 according to the first embodiment are labeled with the same reference numeral, and description thereof will be omitted.

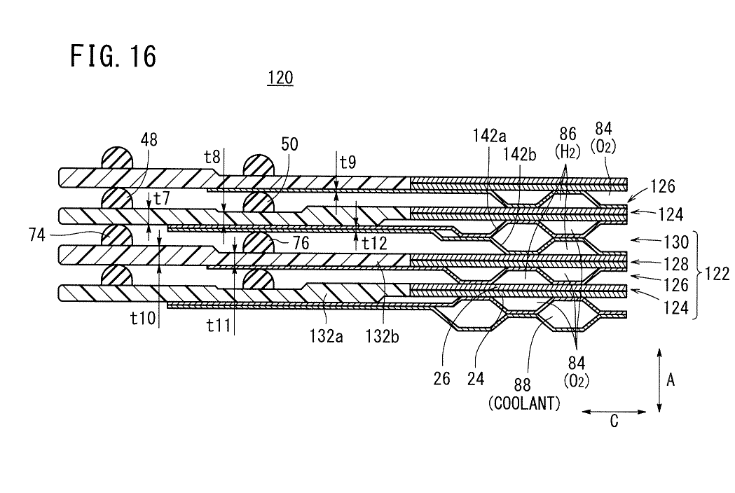

As shown in FIGS. 15 and 16, the fuel cell 120 is formed by stacking a plurality of cell units 122, and each of the cell units 122 includes a first membrane electrode assembly (electrolyte electrode assembly) (MEA) 124, a first metal separator 126, a second membrane electrode assembly (electrolyte electrode assembly) (MEA) 128, and a second metal separator 130. The first membrane electrode assembly 124 and the second membrane electrode assembly 128 include a resin frame member 132a and a resin frame member 132b, respectively.

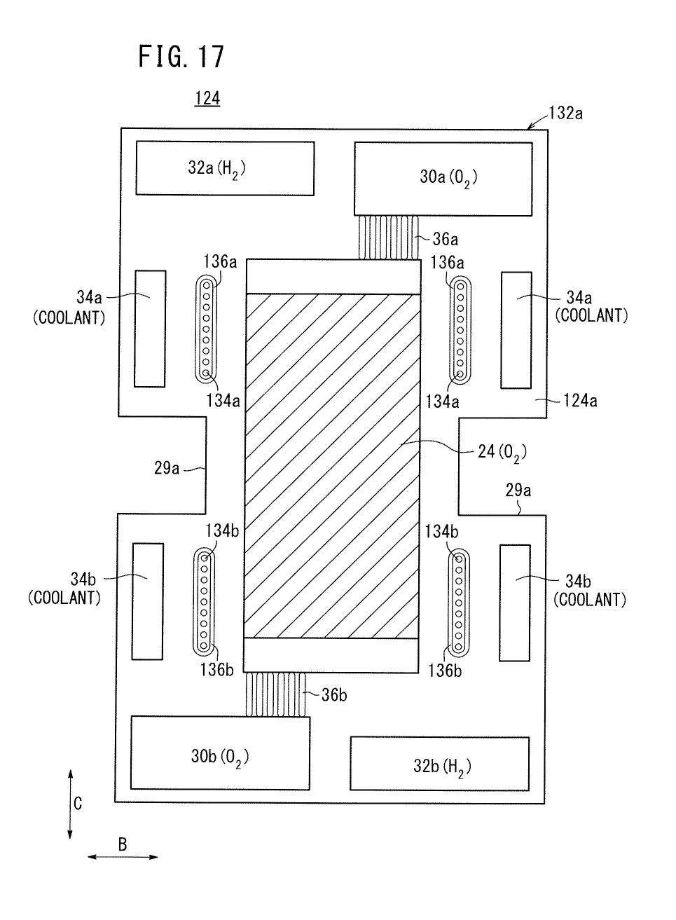

As shown in FIG. 17, at upper positions on both ends of the cathode surface 124a of the resin frame member 132a in the width direction, the inlet grooves 38a are not provided adjacent to the lower side of the coolant supply passages 34a, but a plurality of inlet holes 134a are formed along the width direction of the coolant supply passages 34a in the direction indicated by the arrow C. The inlet holes 134a are surrounded by a ring-shaped inlet seal member 136a.

At lower positions on both ends of the cathode surface 124a of the resin frame member 132a in the width direction, the outlet grooves 38b are not provided adjacent to the upper side of the coolant discharge passages 34b, but a plurality of outlet holes 134b are formed along the width direction of the coolant discharge passages 34b indicated by the arrow C. The outlet holes 134b are surrounded by a ring-shaped outlet seal member 136b.

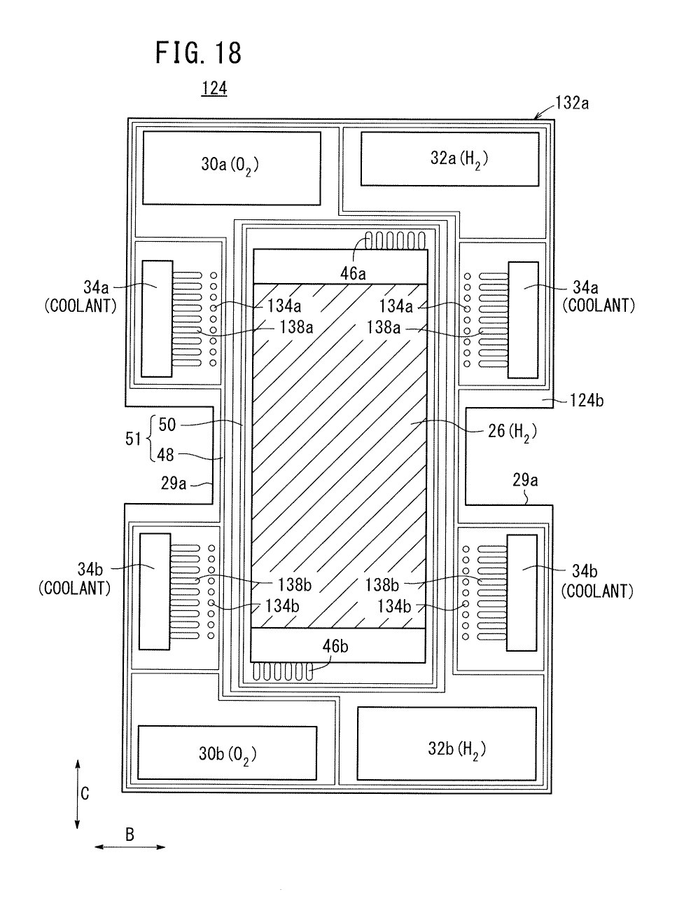

As shown in FIG. 18, at upper positions on both ends of the anode surface 124b of the resin frame member 132a in the width direction, a plurality of inlet grooves 138a corresponding to the inlet holes 134a are provided, and at lower positions on both ends of the anode surface 124b in the width direction, a plurality of outlet grooves 138b corresponding to the outlet holes 134b are provided.

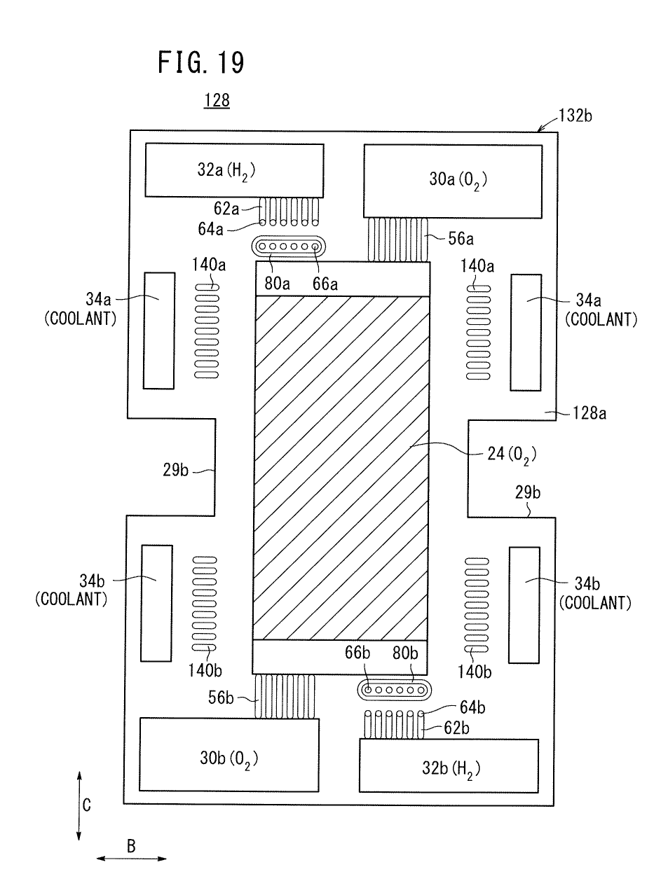

As shown in FIG. 19, at upper positions on both ends of the cathode surface 128a of the resin frame member 132b in the width direction, the inlet holes 60a are not provided adjacent to the lower side of the coolant supply passages 34a, but a plurality of inlet grooves 140a are formed along the width direction of the coolant supply passages 34a.

At lower positions on both ends of the cathode surface 128a of the resin frame member 132b in the width direction, the outlet holes 60b are not provided adjacent to the upper side of the coolant discharge passages 34b, but a plurality of outlet grooves 140b are formed along the width direction of the coolant discharge passages 34b.

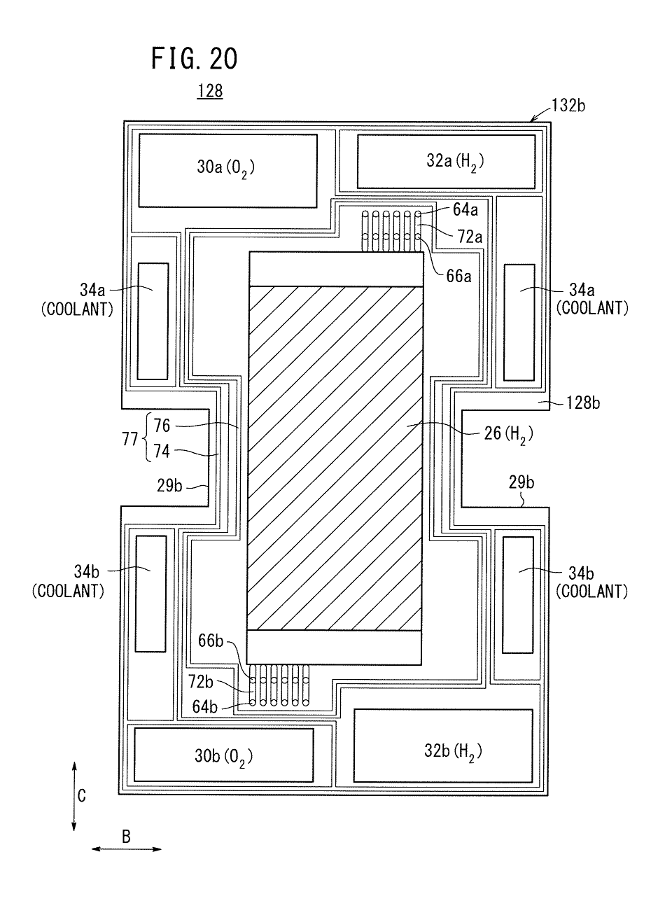

As shown in FIG. 20, the inlet grooves 68a and the outlet grooves 68b are not provided on the anode surface 128b of the resin frame member 132b.

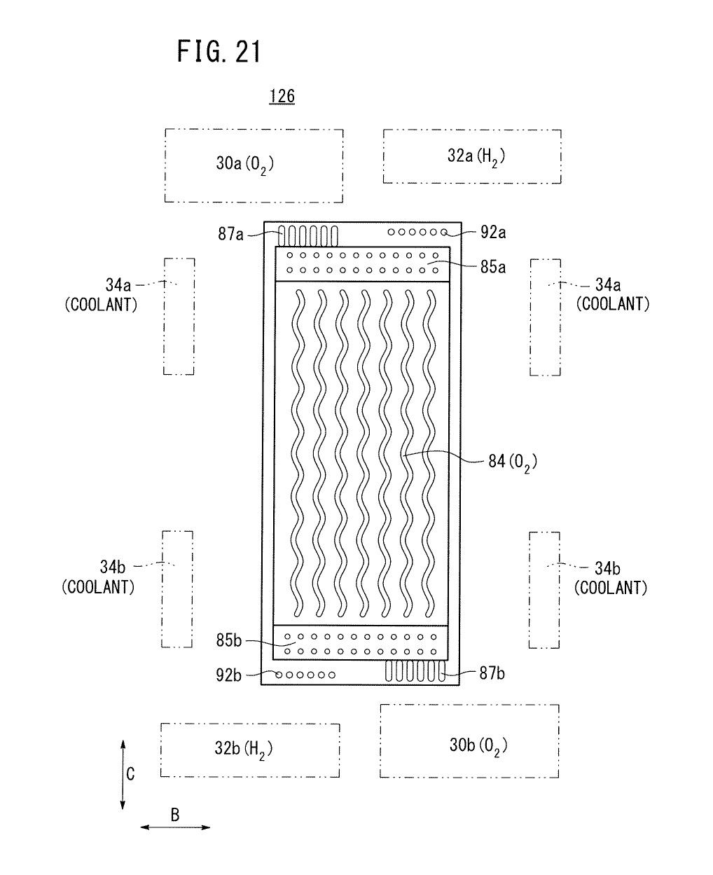

The first metal separator 126 is made of a single metal plate member. As shown in FIG. 21, a plurality of holes 92a and a plurality of inlet grooves 87a are formed above the oxygen-containing gas flow field 84 provided on one surface of the first metal separator 126, and a plurality of holes 92b and a plurality of outlet grooves 87b are formed below the oxygen-containing gas flow field 84.

The pair of projections 89a and the pair of projections 89b are not provided at both ends of the first metal separator 126 in the width direction, and accordingly the holes 90a, 90b are not provided.

As shown in FIG. 16, the second metal separator 130 includes two metal plates (e.g., stainless plates) 142a, 142b having the same outer shape. The metal plates 142a, 142b are stacked together. The outer circumferential edges of the metal plates 142a, 142b are welded or bonded together, and the internal space between the metal plates 142a, 142b is closed hermetically. The metal plate 142a has an oxygen-containing gas flow field 84 facing the cathode 24, and the metal plate 142b has a fuel gas flow field 86 facing the anode 26. A coolant flow field 88 is formed between the metal plates 142a, 142b.

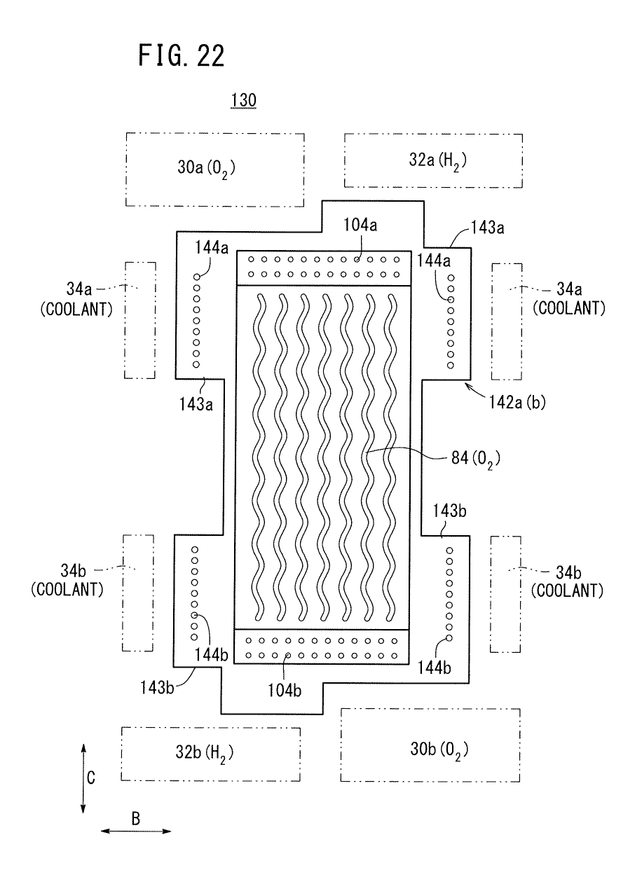

As shown in FIG. 22, a pair of projections 143a relatively elongated in the direction indicated by the arrow C are provided at upper positions on both ends of the metal plate 142a in the width direction. A plurality of holes 144a are formed in the projections 143a along the width direction of the coolant supply passages 34a. A pair of projections 143b relatively elongated in the direction indicated by the arrow C are provided at lower positions on both ends of the metal plate 142a in the width direction. A plurality of holes 144b are formed in the projections 143b along the width direction of the coolant discharge passages 34b.

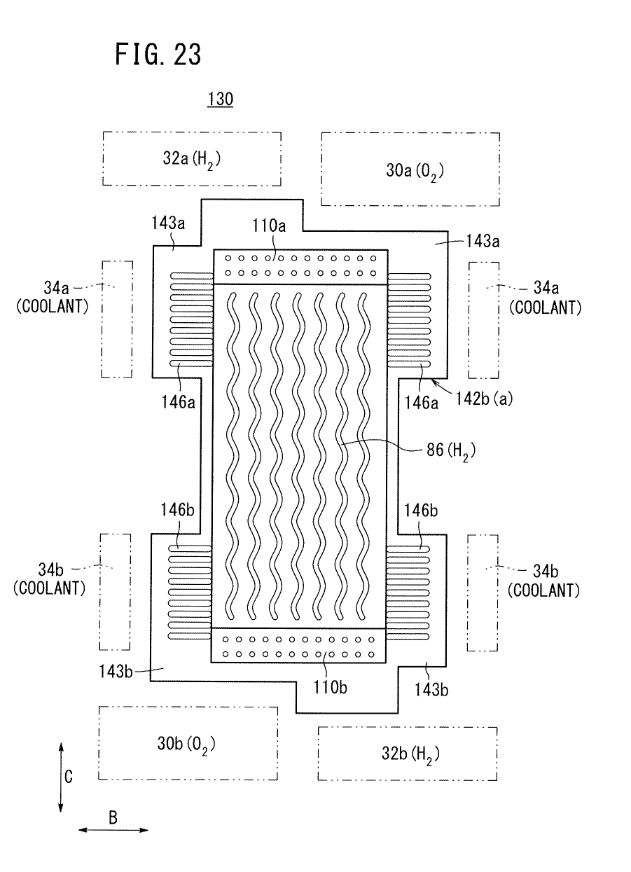

As shown in FIG. 23, a plurality of inlet grooves 146a are formed in the pair of projections 143a of the metal plate 142b along the width direction of the coolant supply passages 34a. A plurality of outlet grooves 146b are formed in the pair of projections 143b of the metal plate 142b along the width direction of the coolant discharge passages 34b.

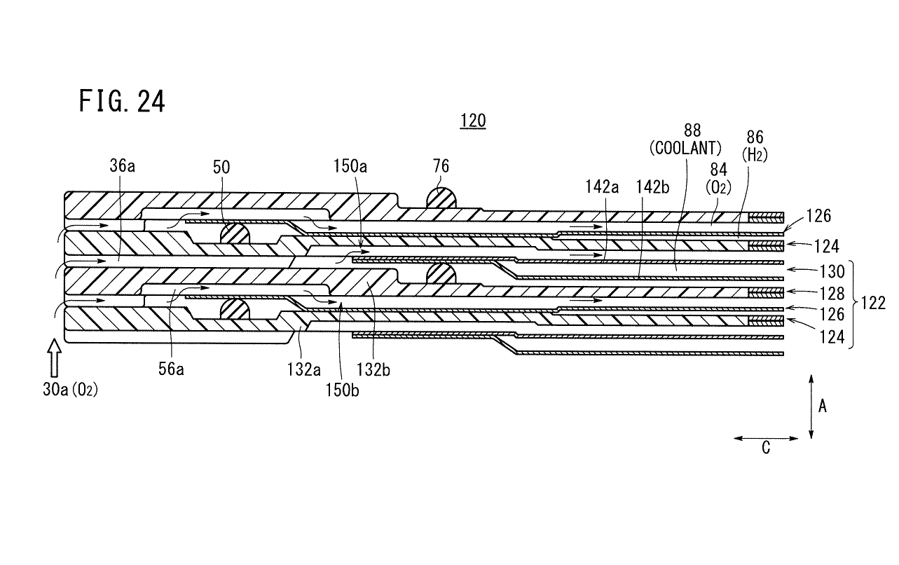

As shown in FIG. 24, an oxygen-containing gas connection channel 150a connecting the oxygen-containing gas supply passage 30a with the oxygen-containing gas flow field 84 of the first membrane electrode assembly 124 and an oxygen-containing gas connection channel 150b connecting the oxygen-containing gas supply passage 30a with the oxygen-containing gas flow field 84 of the second membrane electrode assembly 128 are formed between the resin frame members 132a, 132b that are adjacent to each other in the stacking direction. Though not shown, an oxygen-containing gas connection channel connecting the oxygen-containing gas discharge passage 30b with the oxygen-containing gas flow field 84 is formed between the resin frame members 132a, 132b.

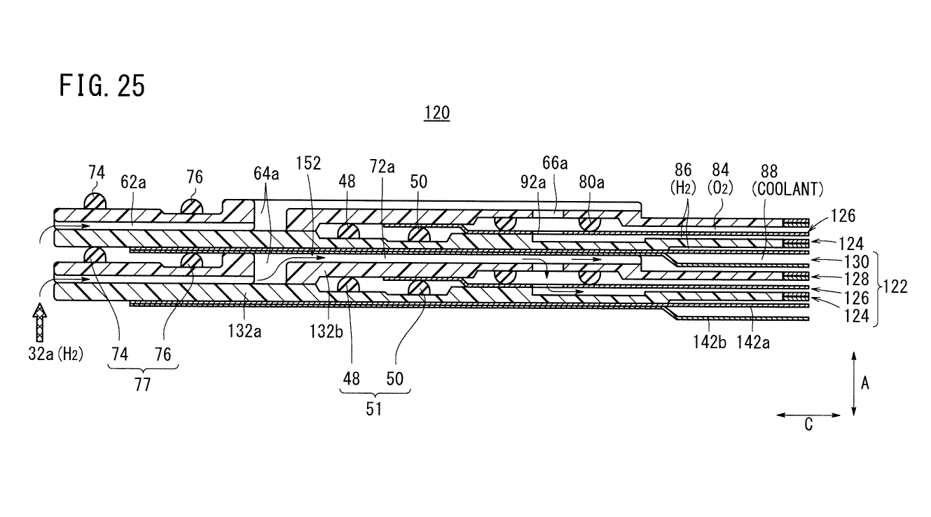

As shown in FIG. 25, a fuel gas connection channel 152 connecting the fuel gas supply passage 32a with the fuel gas flow field 86 is formed between the resin frame members 132a, 132b that are adjacent to each other in the stacking direction. Though not shown, a fuel gas connection channel connecting the fuel gas discharge passage 32b with the fuel gas flow field 86 is formed between the resin frame members 132a, 132b.

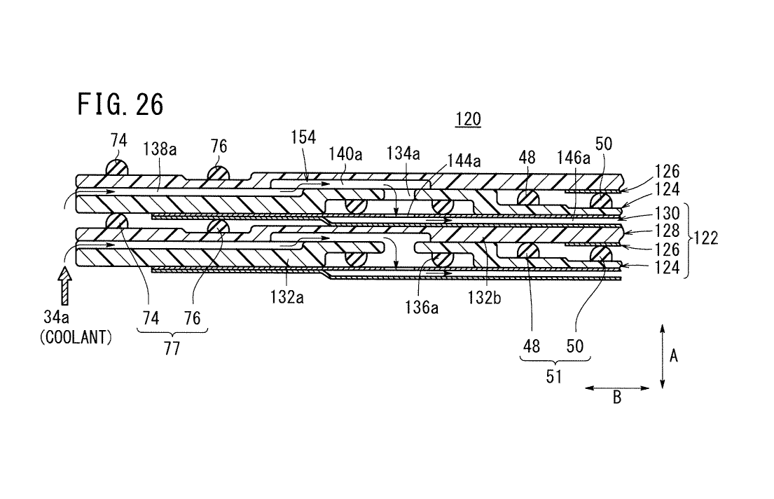

As shown in FIG. 26, a coolant connection channel 154 connecting the coolant supply passage 34a with the coolant flow field 88 of the second metal separator 130 is formed between the resin frame members 132a, 132b that are adjacent to each other in the stacking direction. Though not shown, a coolant connection channel connecting the coolant discharge passage 34b with the coolant flow field 88 is formed between the resin frame members 132a, 132b.

The coolant connection channel 154 is formed by placing an outer seal member 48 and an inner seal member 50 of the resin frame member 132a and an outer seal member 74 and an inner seal member 76 of the resin frame member 132b at different positions in the stacking direction.

The coolant connection channel 154 includes the inlet grooves 138a, 140a provided along the separator surface, the inlet holes (first holes) 134a formed in the resin frame member 132a in the stacking direction, and the holes (second holes) 144a formed in the metal plate 142a in the stacking direction. Ends of the inlet grooves 138a and ends of the inlet grooves 140a are connected together.

As shown in FIG. 16, in the resin frame member 132a (one of the resin frame members), the thickness t7 of a portion where the outer seal member 48 is provided is larger than the thickness t8 of a portion where the inner seal member 50 is provided (t7>t8). The difference between the thickness t7 and the thickness t8 is equal to the thickness t9 of the first metal separator 126 (t7−t8=t9).

The resin frame member 132b (the other of the resin frame members) has a flat surface from a portion which contacts the outer seal member 48 to a portion facing the inner seal member 50. The outer seal member 48 and the inner seal member 50 have the same height, and same seal lip shape.

In the resin frame member 132b (one of the resin frame members), the thickness t10 of a portion where the outer seal member 74 is provided is larger than the thickness t11 of a portion where the inner seal member 76 is provided (t10>t11). The difference between the thickness t10 and the thickness t11 is equal to the thickness t12 of the second metal separator 130 (t10−t11=t12).

The resin frame member 132a (the other of the resin frame members) has a flat surface from a portion which contacts the outer seal member 74 to the portion facing the inner seal member 76. The outer seal member 74 and the inner seal member 76 have the same height, and same seal lip shape.

Operation of the fuel cell 120 will be described briefly below.

In each of the cell units 122, as shown in FIGS. 15 and 24, the oxygen-containing gas supplied to the oxygen-containing gas supply passage 30a flows into the inlet grooves 36a of the first membrane electrode assembly 124 and the inlet grooves 56a of the second membrane electrode assembly 128.

The oxygen-containing gas is supplied from the inlet grooves 36a to the oxygen-containing gas flow field 84 of the second metal separator 130. Then, the oxygen-containing gas is supplied from the oxygen-containing gas flow field 84 to the cathode 24 of the first membrane electrode assembly 124. The remaining oxygen-containing gas after consumption in the power generation reaction is discharged through the outlet grooves 36b into the oxygen-containing gas discharge passage 30b.

The oxygen-containing gas supplied to the inlet grooves 56a flows through the inlet grooves 87a between the second membrane electrode assembly 128 and the first metal separator 126, and the oxygen-containing gas is supplied into the oxygen-containing gas flow field 84 of the first metal separator 126. The oxygen-containing gas is supplied from the oxygen-containing gas flow field 84 to the cathode 24 of the second membrane electrode assembly 128. The remaining oxygen-containing gas after consumption in the power generation reaction is discharged through the outlet grooves 87b, 56b into the oxygen-containing gas discharge passage 30b.

Further, as shown in FIGS. 15 and 25, the fuel gas supplied to the fuel gas supply passage 32a flows into the inlet grooves 62a at the cathode 24 of the second membrane electrode assembly 128. The fuel gas from the inlet grooves 62a flows through the inlet holes 64a toward the anode 26, and part of the fuel gas is supplied from the inlet grooves 72a to the fuel gas flow field 86 of the second metal separator 130.

The remaining fuel gas flows through the inlet holes 66a and the holes 92a of the first metal separator 126, and then, the fuel gas flows into between the first metal separator 126 and the first membrane electrode assembly 124, and the fuel gas is supplied to the fuel gas flow field 86 of the first metal separator 126.

The fuel gas that has been consumed in the power generation reaction in the fuel gas flow field 86 of the second metal separator 130 is discharged into the outlet grooves 72b. Then, the fuel gas flows from the outlet holes 64b, and the fuel gas is discharged through the outlet grooves 62b into the fuel gas discharge passage 32b. In the meanwhile, the fuel gas that has been consumed in the power generation reaction in the fuel gas flow field 86 of the first metal separator 126 flows from the holes 92b and then, the fuel gas is discharged through the outlet holes 66b into the outlet grooves 72b. Likewise, the fuel gas is discharged into the fuel gas discharge passage 32b.

Thus, in the first membrane electrode assembly 124 and the second membrane electrode assembly 128, the oxygen-containing gas supplied to the cathode 24 and the fuel gas supplied to the anode 26 are consumed in electrochemical reactions at catalyst layers of the cathode 24 and the anode 26 for generating electricity.

Further, as shown in FIGS. 15 and 26, the coolant supplied to the pair of coolant supply passages 34a flows into the inlet grooves 138a of the first membrane electrode assembly 124, and then the coolant is supplied from the inlet grooves 140a to the inlet holes 134a. The coolant from the inlet holes 134a flows through the holes 144a of the second metal separator 130, into the second metal separator 130.

The coolant flows inside the second metal separator 130 along the inlet grooves 146a inwardly from both sides in the direction indicated by the arrow B, and then, the coolant is supplied to the coolant flow field 88. The coolant flowing inwardly from both sides collides at a central portion of the coolant flow field 88 in the direction indicated by the arrow B. After the coolant moves in the direction of gravity, the coolant is distributed toward both sides in the direction indicated by the arrow B at a lower portion of the coolant flow field 88. The coolant flows from the outlet grooves 146b through the holes 144b, and then, the coolant is discharged from the second metal separator 130. The coolant flows from the outlet holes 134b through the outlet grooves 140b, 138b, and then, the coolant is discharged into the coolant discharge passage 34b.

In the structure, the first membrane electrode assembly 124 and the second membrane electrode assembly 128 are cooled by skip cooling by the coolant flowing through the coolant flow field 88 of the second metal separator 130.

In the second embodiment, the same advantages as in the case of the first embodiment are obtained. For example, the dual seals 51, 77 have simple and economical structure, and the production cost can be suppressed effectively.

While the invention has been particularly shown and described with reference to preferred embodiments, it will be understood that variations and modifications can be effected thereto by those skilled in the art without departing from the spirit of the invention as defined by the appended claims.

What is claimed is:

1. A fuel cell formed by stacking electrolyte electrode assemblies and metal separators in a stacking direction, the electrolyte electrode assembly each including a pair of electrodes, and an electrolyte interposed between the electrodes, a resin frame member being provided integrally with each outer end of the electrolyte electrode assemblies,
wherein a plurality of fluid passages extend through the resin frame members in the stacking direction for allowing fluids of a fuel gas, an oxygen-containing gas, and a coolant to flow through the fluid passages;
each of the metal separators is interposed between a pair of resin frame members, inwardly of the fluid passages inside the outer ends of the resin frame members;
a dual seal including an inner seal member and an outer seal member having the same height is provided on one of the pair of resin frame members,
a front end of the inner seal member contacts one of the metal separators; and
a front end of the outer seal member contacts the other of the pair of resin frame members.

2. The fuel cell according to claim 1, wherein in the one resin frame member, a thickness of a portion where the inner seal member is provided is smaller than the thickness of a portion where the outer seal member is provided; and
the other resin frame member has a flat surface from a portion facing the inner seal member to a portion which contacts the outer seal member.

3. The fuel cell according to claim 1, wherein the metal separator includes a first metal separator and a second metal separator sandwiching the electrolyte electrode assembly; and
at least the first metal separator or the second metal separator includes two plates, and a coolant flow field is formed between the two plates.

4. The fuel cell according to claim 3, wherein the two plates have the same outer shape.
